(19) United States
(12) Patent Application Publication
(10) Pub. No.: US 2011/0077927 A1
(43) Pub. Date: Mar. 31, 2011

(54) Generalized Constitutive Modeling Method and System

(76) Inventor: Richard W. Hamm, Loveland, OH (US)

(21) Appl. No.: 12/961,910

(22) Filed: Dec. 7, 2010

Related U.S. Application Data
(63) Continuation-in-part of application No. 11/893,784, filed on Aug. 17, 2007.

(51) Int. Cl. G06G 7/48

(52) U.S. Cl. 703/6

(57) ABSTRACT

A method of modeling a material using a generalized constitutive model includes assembling a plurality of behaviors the plurality of behaviors including distinct stress derived loading and unloading behaviors, the plurality of behaviors assembled without reference to a particular material to be modeled, and assembling a plurality of couplings, each of the plurality of couplings associated with at least one of the behaviors of the plurality of behaviors and defined without reference to a particular material to be modeled. The method also includes selecting at least one behavior from the plurality of behaviors to define a model for a particular material, performing simulations using the model for the particular material to define a simulation output, and making a determination regarding the material according to the simulation output. A system is also provided to carry out the method.

### CROSS REFERENCE TO RELATED APPLICATION

This application is a continuation-in-part of prior U.S. application Ser. No. 11/893,784 filed on Aug. 17, 2007, which is incorporated by reference.

### FIELD OF THE INVENTION

The present disclosure generally relates to a method and system for modeling articles, such as consumer goods, and particularly to a computerized method and system for constitutive modeling of such articles.

### BACKGROUND OF THE INVENTION

Finite element analysis (FEA) has been of significant assistance in reducing product costs and improving product quality. Once a computer model has been created for a given material, the model may be used to determine how a product using that material may respond, for example, to a variety of different loading conditions. A considerable savings, in terms of time and money, may be realized in conducting computer simulations instead of performing tests in a laboratory.

At the present time, most material models are created on a case-by-case basis. That is, a test matrix is created to organize a set of tests, which tests are designed to obtain information about the performance of a material under various loadings. The testing is performed, and the results are analyzed. Based on this analysis, the model creator selects certain behaviors, which behaviors may be suggested by the test results. The model creator then relates the behaviors, resulting in a set of coupled equations, for example. The analysis of the test results and selection of the behaviors requires great skill and experience. It is not uncommon for those persons whose job it is to create computer models to hold advanced degrees.

It will thus be recognized that model creation may be beyond the skills of the average technologist whose job it is to select the materials or processing conditions for a new product.

On one level, it is unlikely that the average technologist will have the experience necessary to be able to judge and select a suitable behaviors from among those available. For that matter, it is unlikely that average technologist will have the skill set necessary to modify the model, even if the process involves simply modifying the coefficients according to test results.

Consequently, it would be desirable to provide a system and a method that permitted the average technologist to create a model for a new product. It may also be desirable to provide a system and a method that educated the technologist while assisting the technologist to create the model.

### SUMMARY OF THE INVENTION

According to one aspect, a method of modeling a material using a generalized constitutive model includes assembling a plurality of behaviors, the plurality of behaviors assembled without reference to a particular material to be modeled, and assembling a plurality of couplings, each of the plurality of couplings associated with at least one of the behaviors of the plurality of behaviors and defined without reference to a particular material to be modeled. The method also includes selecting at least one behavior from the plurality of behaviors to define a model for a particular material, performing simulations using the model for the particular material to define a simulation output, and making a determination regarding the material according to the simulation output.

According to another aspect, a system for modeling a material using a generalized constitutive model includes a processor operatively coupled to a memory, a plurality of behaviors stored in the memory, the plurality of behaviors assembled without reference to a particular material to be modeled, and a plurality of couplings stored in the memory, each of the plurality of couplings associated with at least one of the behaviors of the plurality of behaviors and defined without reference to a particular material to be modeled. The processor is programmed to select at least one behavior from the plurality of behaviors to define a constitutive model for a particular material, and the processor is programmed to perform simulations using the constitutive model.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is block diagram of a computer system for use with the generalized constitutive modeling method according to the present disclosure, and which may form, at least in part, the generalized constitutive modeling system according to the present disclosure;

FIG. 2 is a flowchart illustrating steps that may be included in the generalized constitutive modeling method according to the present disclosure;

FIGS. 3A-C are flowcharts illustrating actions that may be included in a method of guiding a user's selection of one or more behaviors from the generalized constitutive model according to the present disclosure and modifying the model so defined; and

FIG. 4 is a schematic of a display of a worksheet or template to be used in conjunction with the method of FIGS. 3A-C.

FIG. 5 is a graphical depiction of the stress-strain relationship characteristic of the Mullins Effect.

FIG. 6 is a graphical depiction of the loading and unloading curves associated with the Mullins Effect.

### DETAILED DESCRIPTION OF THE INVENTION

The present disclosure details a method and a system for modeling a material using a generalized constitutive model. The generalized model may include a plurality of behaviors, the plurality of behaviors assembled without reference to a particular material to be modeled. The generalized model may also include a plurality of couplings, each of the couplings associated with at least one of the behaviors from the plurality of behaviors. The plurality of couplings, like the plurality of behaviors, is assembled without reference to a material to be modeled. Thus, unlike the convention method described above, the system and method of the present disclosure do not use as their starting point models including behaviors and couplings selected according to a particular material to be modeled.

The method and system according to the present disclosure selects from among the plurality of behaviors and plurality of couplings that define the generalized constitutive model those behaviors and couplings appropriate for a particular material to be modeled. In certain embodiments, the selection may be based on a database of accumulated knowledge concerning the selection. As such, the selection of the behaviors and couplings may be performed according to relationships identified in the creation of models for similar materials. Alternatively, the selection of behaviors and couplings may be performed according to relationships identified during testing of the same or similar materials. In certain embodiments, the selection may be in response to an input received from a user, such as an analysis or technologist. The user input may be in the form of responses to a plurality of questions regarding the material to be modeled. The user input may be used to select a template, which template is associated with a class of materials, for example.

The method and system may also modify the couplings according to results of testing of the model. For example, associated with the couplings may be a matrix of coefficients, which matrix is an expression of the couplings. The method and system may perform one or more simulations using the model created from the selection from among the behaviors and couplings according to the default matrix. The method and system may then compare the output of the simulation to a set of test results received from the user. The method and system may then attempt to modify the coefficients according to a desired relationship between the simulation output and the test results.

As a consequence of the foregoing, the method and system may provide a model for the material under consideration that may be used in simulations of the material. The simulations may be used, for example, to determine if a particular material should be selected for a particular product according to its performance under various loadings, for example. Similarly, models may be prepared for a plurality of candidate materials, and simulations conducted to determine which material from the plurality of candidate materials should be selected. As another example, the simulations may be used to determine how insensitive a material is to variations in regard to a particular loading by performing a plurality of simulations with the same model under varying loading conditions.

While simplification of the process of model creation may be one aspect of the system, the system may also have an educational aspect in addition. That is, given the collected knowledge, expertise, and experience reflected in the system, the output of the system may be provided in such a manner as to educate the user, for example a technologist, and develop his or her appreciation of the relationships between the materials, test results, and/or behaviors that may be incorporated into a model for a material. In this fashion, embodiments of the system may work not simply to create models, although certain embodiments may be designed simply to ease model creation.

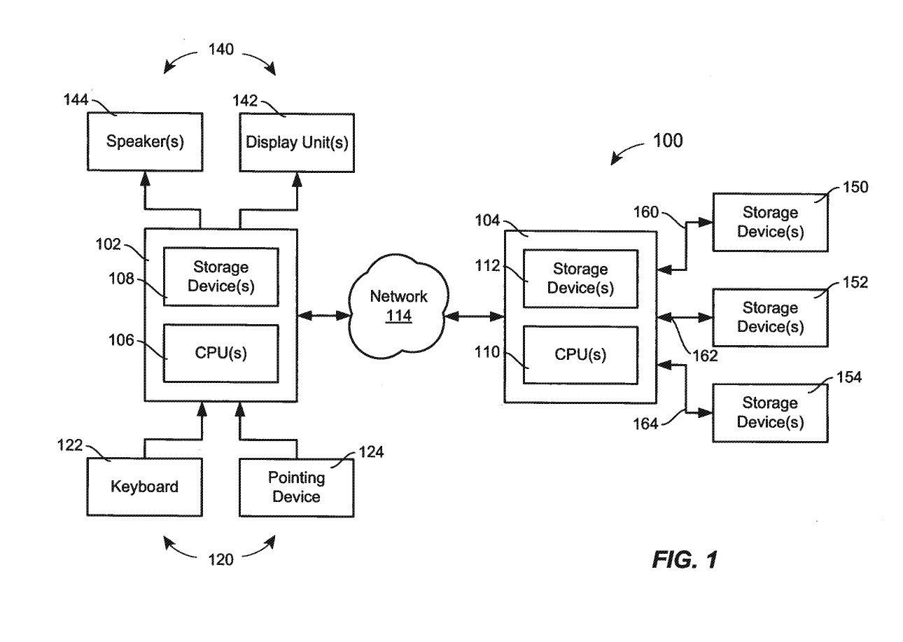

One embodiment of a computer system 100 for use with the method and system according to the present disclosure is illustrated in FIG. 1. The computer system 100 may include a first computing device 102 and a second computing device 104. The computing device 102 may include a processor 106 and a storage medium or device 108 operatively coupled to the processor 106. Similarly, the computing device 104 may also include a processor 110 and a storage medium or device 112 operatively coupled to the processor 110.

The processors 106, 110 may be defined by one or more physical and/or logical units. Similarly, the storage devices 108, 112 may include multiple units. Although the processors 106, 110 and the respective storage devices 108, 112 are illustrated as internal to the computing devices 102, 104, the processor and storage devices need not be located in the same physical space or physically-proximate to each other. Moreover, the data storage device 108, 112 may include a data storage medium interface (e.g., a magnetic disk drive, a compact disk (CD) drive or a digital versatile disk drive (DVD) and an associated data storage medium (e.g., a magnetic disk, a CD or a DVD). In fact, the data storage device 108, 112 may be in the form of any machine-accessible medium.

A machine accessible medium includes any mechanism that provides (i.e., stores and/or transmits) information in a form accessible by a machine (e.g., a computer, workstation, Linux device, network device, manufacturing tool, any device with a set of one or more processors, etc.). For example, a machine accessible medium includes recordable/non-recordable magnetic, optical and solid-state media (e.g., read-only memory (ROM), programmable read-only memory (PROM), erasable programmable read-only memory (EPROM), electrically erasable programmable read-only memory (EEPROM), random access memory (RAM), magnetic disk storage media, optical storage media, flash memory devices, etc.), as well as electrical, optical, acoustical or other form of propagated signals (e.g., carrier waves, infrared signals, digital signals, etc). Stored in the data storage device 108, 112 and executable by the processor 106, 110 may be a model and a code, which performs the numerical solution of the model.

The first computing device 102 may be coupled to the second computing device 104 via a link 114. The link 114 may be in the form of a cable connected directly between the computing devices 102, 104. The link 114 may be in the form of a wireless connection, such as an infrared connection or a radio-frequency connection (e.g., Bluetooth). The link 114 may also include a network, such as a Local Area Network (LAN), Wide Area Network (WAN), a wireless network (IEEE 802.11a, IEEE 802.11b, IEEE 802.16), an intranet, the Internet, etc. As illustrated, the link 114 is defined, at least in part, by a network.

One of the two computing devices 102, 104 may be configured as a client machine, and the other as a server. As illustrated, the computing device 102 would be the client, while the computing device 104 would be the server. According to certain embodiments, the computing device 102 may be a particular type of client machine, referred to as a “thin client,” wherein the bulk of the data processing occurs at the computing device 104. However, it is also within the scope of the present disclosure to have the computing devices 102, 104 configured to operate in accordance with a peer-to-peer network.

The computing device 102 may include a number of input devices 120 and output devices 140. In particular, the computing device 102 may include input devices 120 in the form of a keyboard 122 and a pointing device 124, such as a mouse. Alternative input devices 120 such as keypads, touch screens, light pens, card readers, etc. may be included. The computing device 102 may also include output devices 140 in the form of a display unit 142 (e.g., cathode ray tube (CRT), liquid crystal display (LCD), etc.) and speakers 144. Alternative output devices 140 such as printers, storage medium writers, etc. may be included.

Depending on the implementation of the computing device 102, one or more of the input devices 120 and output devices 140 may be incorporated with the processor 106 and storage device 108 into a common housing. For example, if the computing device 102 is a laptop, the keyboard 122, pointing device 124, display unit 142 and speakers 144 may reside in a common housing with the processor 106 and storage device 108 as part of a unitary device. Alternatively, if the computing device 102 is a desktop, the processor 106 and storage device 108 may reside in a first housing, to which the various input devices 120 (keyboard 122, pointing device 124) and output devices 140 (display unit 142, speakers 144) may be operatively coupled. The operatively coupling may be in the form of wired or wireless (infrared, radio-frequency) couplings.

The computing device 104 may be coupled to a plurality of storage devices 150, 152, 154. The storage devices 150, 152, 154 may be defined by separate physical structures. Alternatively, the storage devices 150, 152, 154 may be defined as separate physical or logical substructures of a single physical structure. As one example, the storage devices 150, 152, 154 may be three separate databases, each of which resides on a separate computing device configured as a server. Alternatively, each of the storage devices 150, 152, 154 may be a logical database stored on a single computing device configured as a single server. Given the various arrangements possible, the links 160, 162, 164 between the computing device 104 and the storage devices 150, 152, 154 may represent a separate cables connected between the computing device 104 and the storage devices 150, 152, 154, separate data links operating over a single cable or a single network link, etc.

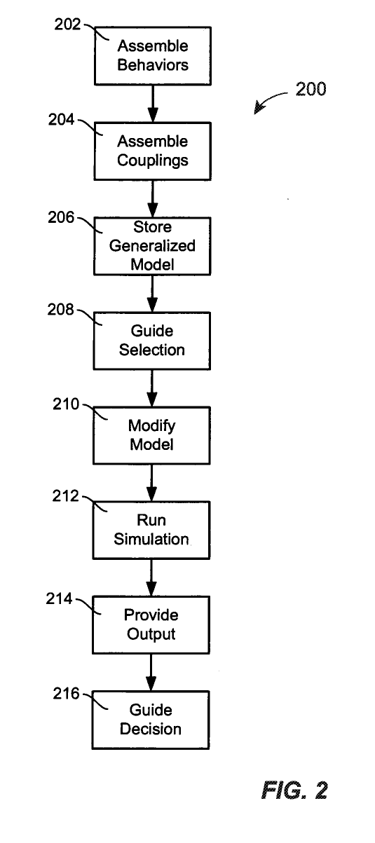

Reference is now made to the method 200 illustrated in FIG. 2, which method 200 may be embodied in a program stored and executed, for example, at the computing device 102, at the computing device 104 or at both. The method 200 begins with several steps (202, 204, 206) which are preliminary in nature. The preliminary steps involve the assembly of the generalized constitutive model, or more particularly the plurality of behaviors (block 202) and the plurality of couplings (block 204) that define the generalized constitutive model, and the storage of the model (block 206).

In assembling the behaviors to be included at block 202, as mentioned above, reference is not made to the material to be modeled. Instead, the generalized constitutive model includes a wide range of behaviors, one or more of which may be incorporated in a model for a new material. As such, the listing of behaviors that might be included is illustrative, and thus non-limiting. Moreover, to the extent that some attempt has been made to group the behaviors into classes, the classification is based on beliefs at the present time, and may be subject to change.

The classes or groups of behaviors may include: elastic behaviors, plastic behaviors, rate effect behaviors, damage behaviors, failure behaviors, environmental behaviors, and size effect behaviors. Within each group of behaviors are one or more individual behaviors, which individual behaviors may be selected for inclusion in the model for the new material. Each class is now discussed in detail.

Elastic behaviors may include isotropic, transversely isotropic, orthotropic and anisotropic linear and nonlinear behaviors. The elastic behaviors may also include asymmetric behaviors, both linear and nonlinear, with respect to tension and compression. The elastic behavior may also include bilinear (“fabric”) behavior, isotropic or orthotropic, with an option to model ratcheting.

The plastic behaviors may be discussed in regard to two sub-groups. The first subgroup may include those plastic behaviors that relate to yield criteria. The second subgroup may include those behaviors that related to yield hardening.

The first, or yield criteria, subgroup may include mises, Hill, various Drucker-Prager, and foam models. The yield criteria subgroup may also include a Continuous Cap model. C. D. Foster, R. A. Regueiro, A. F. Fossum, R. I. Borja, Implicit Numerical Integration Of A Three-Invariant Isotropic/Kinematic Hardening Cap Plasticity Model For Geomaterials, Computer Methods in Applied Mechanics And Engineering, 194 (2005), pp. 5109-5138. Further, the yield criteria may include non-quadratic yield criteria. Xia, Boyce and Parks, International Journal of Solids and Structures, 39, pp. 4053-4071 (2002); Xia, Mechanics of Inelastic Deformation and Delamination of Paperboard, Dissertation MIT, (2002). There may also be a plurality of yield criteria where the yield behavior in the various tensorial directions can be made independent of each other or may be grouped together as appropriate. For example, the 1 and 2 directions may use the same yield criterion, while the 3 direction may employ a different yield criterion and the shear directions (e.g., 4, 5 and 6) may have another yield criterion.

The second, or yield hardening, subgroup may include isotropic hardening. Further, the yield hardening subgroup may include kinematic hardening, according to Armstrong-Frederick, Voyiadjis-Kattan, or some other multi-term nonlinear rule. G. Z. Voyiadjis, R. K. A. Al-Rub, Thermodynamic Based Model for the Evolution Equation of the Backstress in Cyclic Plasticity, International Journal Of Plasticity, 19, pp. 2121-2147 (2003).

Rate effect behaviors may include viscoelasticity and viscoplasticity. Viscoelasticity may be expressed in terms of stress relaxation and creep response according to a Prony series methodology, and may include as many terms as there are data points for which to fit the Prony series. Time or frequency may be required as an input to such a behavior, and it is preferably, although not necessary, to have the ability to utilize time-master curves. Viscoplasticity may be expressed by any one or a combination of a number of standard viscoplastic flow models, such as Norton, Hyberbolic and Strain Hardening flow. Here, it is preferably, although not necessary, that primary as well as secondary creep should be addressed, in addition to high strain rate effects. Preferably, although not necessarily, the model(s) should be able to handle rates from quasistatic to ballistic speeds (≧1000 s-1).

Damage behaviors may include isotropic, orthotropic, and anisotropic behaviors. The damage behaviors may also include adhesion. As to adhesion, the behaviors may address degradation of peel, tack or shear loading strength due to debonding and re-adhering.

Failure behaviors may address chain stretch. Bergstrom, Rimnac, Kurtz, Molecular Chain Stretch as a Multiaxial Failure Criterion For Conventional And Highly Crosslinked UHMWPE, Journal of Orthopedic Research (2004). The failure behaviors may be equivalent strain or stress based, in which failure is based on reaching an equivalent stress or strain that can vary as a function of hydrostatic pressure. The failure behaviors may include orthotropic failure, such as an extension of Tsai-Hill criterion to three dimensions. Failure behaviors may address through thickness delamination (Xia, Mechanics of Inelastic Deformation and Delamination of Paperboard, Dissertation MIT (2002)) or adhesive type failures, such as peel, tack or shear loading debonds. Failure may also be defined by strain energy density or stress impulse metrics including, but not limited to, the Tuler-Butcher criterion.

Environmental behaviors may address thermal and moisture effects. Such effects may include expansion, contraction and swelling. Such effects may also include changes to various model parameters, through either solution dependent temperature and/or field variables or prescribed field variables. The effects may evolve in monotonic or non-monotonic increasing or decreasing manner.

A variety of other behaviors may also be included, which behaviors are not particularly addressed above. For example, the behaviors may include finite deformation. The behaviors may also include strain localization to account for necking phenomenon at various rates and temperatures. Polymer crystallinity and/or crosslink effects may be included. Dommelen, Parks, Boyce, et al., Journal of Mechanics and Physics of Solids, 51, p. 519-541 (2003); Bergstrom, Rimnac, Kurtz, Prediction of Multiaxial Mechanical Behavior for Conventional And Highly Crosslinked UHMWPE Using A Hybrid Constitutive Model, Biomaterials, 24, pp. 1365-1380 (2003). The behaviors may also address the extent to which crystallinity field drives property evolution. The behaviors may also address general state variable effects in the form of user defined variables that could be used to simulate physics not explicitly included in the FEA codes, such as chemical aging, plasticization and other effects not explicitly called out above by modifying the values of the model parameters by functional relationships with said state variables.

A variety of elastomeric systems are susceptible to stress softening arising from multiple cycles of stress loading and unloading of the materials and the articles the materials comprise. This includes films non-wovens and fibrous materials. Stress softening has been observed in semicrystalline materials such as thermoplastic elastomers as well as materials that exhibit strain induced crystallization and amorphous materials. This softening has been linked to a variety of phenomena such as deformation induced anisotropy. Several physical mechanisms contribute to softening including rupture of molecular bonds, network rearrangement vial molecular slippage or disentanglement with maximum entropic conformation or filler rupture. The manifestation of these mechanisms is typically referred to as the Mullins Effect. Unlike the irreversible behaviors traditional continuum damage mechanics models seek to replicate, such as microvoid formation (cavitation) and growth, the Mullins Effect recovers with time and that the recovery is accelerated by annealing.

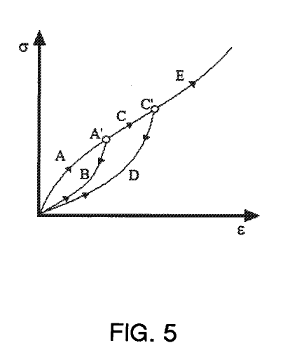

A Mullins Effect representation is shown in FIG. 5. Consider a virgin material that is stretched along Path A until it reaches A′. During the loading process, damage is accumulating. The material is then unloaded. Assuming no rate effects, the material's strength is reduced, so it will unload along Path B. Upon reloading, it will follow Path B until it reaches Point A′. If the material is deformed past A′ it will follow Path C′ and continue to accumulate damage until C′, where it is allowed to elastically unload. As the material reloads, it will follow Path D without accumulating damage until C′. Beyond that point, further damage is incurred while on Path E. A model of the Mullins effect may be expressed in the following form:

σ̅=ησ

### Where:

σ=Stress response of the virgin material
η=Scalar variable that accounts for damage

$$η = 1 - \frac{1}{r} Erf ( \frac{{U}_{dev}^{max} - {\tilde{U}}_{dev}}{m + β {U}_{dev}^{max}} )$$

### Where:

r, m, β=Model parameters
U_{dev}^{max}=Maximum deviatoric strain energy density achieved during deformation history.
Ü_{dev}=Current deviatoric strain energy density, calculated from the virgin response for a given deformation.
Erf(x)=Gaussian Error Function

$$Erf ( x ) = \frac{2}{\sqrt{π}} {\int }_{0}^{x} exp ( - {y}^{2} ) d y$$

While loading virgin material, the deviatoric strain energy density is equal to its maximum value, so η=1. During unloading however, η<1, resulting in stress softening. Due to the form of η, the model parameters must satisfy: r>1.0, m≧0.0, β≧0.0, mβ>0.0

### Viscoelasticity Fully Coupled With the Mullins Effect

For the coupled approach, the relaxation times are dependent upon both viscous and stiffness elements and, according to

$${τ}_{i} = \frac{{η}_{i}}{{E}_{i}} ,$$

relaxation times become τᵢ=τᵢ/η while the instantaneous stress changes to ηS. Here and going forward, η refers to the Mullins softening parameter. The relative stiffness parameters, γᵢ, remain the same according to:

$${γ}_{i} = \frac{{E}_{i}}{{E}_{0}} , {γ}_{∞} + {\sum }_{i = 1}^{N} {γ}_{i} = 1.$$

Consider the internal state variable hᵢ including softening:

$${h}_{i} ( {t}_{n + 1} ) = {\int }_{{t}_{0}}^{{t}_{n + 1}} exp ( \frac{- ( {t}_{n + 1} - s )}{{τ}_{i} / η ( s )} ) \frac{d}{d s} ( η S ) d s$$

$$\begin{matrix}{h}_{i} ( {t}_{n + 1} ) = {\int }_{{t}_{0}}^{{t}_{n} + Δ {t}_{n}} exp ( \frac{- ( {t}_{n} + Δ {t}_{n} - s )}{{τ}_{i} / η} ) \frac{d}{d s} ( η S ) d s \\ = {\int }_{{t}_{0}}^{{t}_{n}} exp ( \frac{- ( Δ {t}_{n} )}{{τ}_{i} / η} ) exp ( \frac{- ( {t}_{n} - s )}{{τ}_{i} / η} ) \frac{d}{d s} ( η S ) d s + \\ {\int }_{{t}_{n}}^{{t}_{n + 1}} exp ( \frac{- ( {t}_{n + 1} - s )}{{τ}_{i} / η} ) \frac{d}{d s} ( η S ) d s \\ \approx exp ( \frac{- 2 ( Δ {t}_{n} )}{{τ}_{i} ( 1 / η ( {t}_{n} ) + 1 / η ( {t}_{n - 1} ) )} ) {h}_{i} ( {t}_{n} ) + \\ {\int }_{{t}_{n}}^{{t}_{n + 1}} exp ( \frac{- ( {t}_{n + 1} - s )}{{τ}_{i} / η} ) \frac{d}{d s} ( η S ) d s\end{matrix}$$

Using the midpoint rule for the integral above, results in:

$$\begin{matrix}{\int }_{{t}_{n}}^{{t}_{n + 1}} exp ( \frac{- ( {t}_{n + 1} - s )}{{τ}_{i} / η ( s )} ) \frac{d}{d s} ( η S ) d s \approx exp ( \frac{- ( {t}_{n} + Δ {t}_{n} - s )}{{τ}_{i} / η ( s )} ) \\ { \frac{d}{d s} ( η S ) Δ {t}_{n} \vert}_{s = \frac{{t}_{n} + {t}_{n + 1}}{2}} \\ = exp ( \frac{- Δ {t}_{n}}{2 {τ}_{i} / η ( \frac{{t}_{n} + {t}_{n + 1}}{2} )} ) \\ ( \frac{1}{2} ( ( S ( {t}_{n + 1} ) - S ( {t}_{n} ) ) ( η ( {t}_{n + 1} ) + η ( {t}_{n} ) ) + \\ ( S ( {t}_{n + 1} ) + S ( {t}_{n} ) ) ( η ( {t}_{n + 1} ) - η ( {t}_{n} ) ) )\end{matrix}$$

assuming

$$1 / η ( \frac{{t}_{n} + {t}_{n + 1}}{2} ) \approx \frac{1 / η ( {t}_{n} ) + 1 / η ( {t}_{n + 1} )}{2}$$

then:

$${\int }_{{t}_{n}}^{{t}_{n + 1}} exp ( \frac{- ( {t}_{n + 1} - s )}{{τ}_{i} / η ( s )} ) \frac{d S}{d s} d s \approx exp ( \frac{- Δ {t}_{n}}{{τ}_{i} ( 1 / η ( {t}_{n} ) + 1 / η ( {t}_{n + 1} ) )} ) ( S ( {t}_{n + 1} ) η ( {t}_{n + 1} ) - S ( {t}_{n} ) η ( {t}_{n} ) )$$

Substituting this back into:

$$σ ( t ) = {\int }_{- ∞}^{t} e ( t - s ) \frac{\partial S}{\partial s} d s ,$$

where:

$$e ( t ) = {γ}_{∞} + {\sum }_{i = 1}^{N} {γ}_{i} exp ( - \frac{t}{{τ}_{i}} ) = \frac{E ( t )}{{E}_{0}} ,$$

yields:

$$σ ( t ) = {\int }_{- ∞}^{t} ( {γ}_{∞} \frac{\partial }{\partial s} ( η S ) + \sum {γ}_{i} exp ( \frac{- ( t - s )}{{τ}_{i} / η} ) \frac{\partial }{\partial s} ( η S ) ) d s$$

or:

$$σ ( {t}_{n + 1} ) = {γ}_{∞} S ( {t}_{n + 1} ) η ( {t}_{n + 1} ) + {\sum }_{i = 1}^{N} {γ}_{i} {h}_{i}$$

Where hᵢ is:

$${h}_{i} ( {t}_{n + 1} ) = exp ( \frac{- 2 ( Δ {t}_{n} ) / {a}_{T}}{{τ}_{i} ( 1 / η ( {t}_{n} ) + 1 / η ( {t}_{n - 1} ) )} ) {h}_{i} ( {t}_{n} ) + exp ( \frac{- Δ {t}_{n} / {a}_{T}}{{τ}_{i} ( 1 / η ( {t}_{n} ) + 1 / η ( {t}_{n + 1} ) )} ) ( S ( {t}_{n + 1} ) η ( {t}_{n + 1} ) - S ( {t}_{n} ) η ( {t}_{n} ) )$$

Here, η is determined from the strain energy density of the un-softened instantaneous response, S. The formulation is equivalent to introducing a modified energy potential with a “damage” function, as outlined by Ogden, R. W., and D. G. Roxburgh, “A Pseudo-Elastic Model for the Mullins Effect in Filled Rubber,” Proceedings of the Royal Society of London, Series A, vol. 455, pp. 2861-2877, 1999. Hence, the Clausius-Duhem inequality is satisfied for thermodynamic compatibility.

### A Simple Example of the Mullins Effect

As an example of how the Mullins Effect model works, consider the following ldimensional example. Instead of the damage parameter, η, equal to the above equation, let it equal:

$$η = \frac{ɛ}{{ɛ}_{M}} , \overline{σ} = ησ$$

### Where:

E=current strain
ε_{M}=maximum strain reached

$$\begin{matrix}σ = stress \text{-} strain response in the virgin material \\ = E ɛ\end{matrix}$$

The resulting stress-strain relation becomes:

$$\overline{σ} = E \frac{{ɛ}^{2}}{{ɛ}_{M}}$$

The energy dissipation is given by:

$${φ}_{D} = E ( \frac{{ɛ}_{M}^{2}}{2} - {\int }_{ɛ}^{{ɛ}_{M}} \frac{{v}^{2}}{{ɛ}_{M}} d v ) = \frac{E ( {ɛ}_{M}^{3} + 2 {ɛ}^{3} )}{6 {ɛ}_{M}}$$

While the material is being loaded monotonically, ε=ε_{M} and the response reduces back to the virgin response. But, during unloading, softening occurs, with the stress reduced by ε/ε_{M}.

### Scanning Mullins Effect Model

With the intention of increase the fitting and prediction flexibility of the tool, a “Scanning” version of the Mullins Effect has been developed that provides different softening during loadings and unloadings. Other investigators have developed similar concepts for describing rate independent hysteresis in hyperelastic models, although their implementations are different. See for example Feng, W. W., and Hallquist, J. O. “Numerical Modelling and Biaxial Tests for the Mullins Effect in Rubber”, Proceedings of the 6^{th} European LS-Dyna User's Conference, 2007, pp. 1.163-1.172, Drozdov, A. D., “Mullins Effect in Thermoplastic Elastomers: Experiments and Modeling”, Mechanics Research Communications, 2009, doi:10.1016/j.mechrescom. 2008.12.07, Pena, E., et al., “A Constitutive Formulation of Vascular Tissue Mechanics Including Viscoelasticity and Softening Behavior”, Journal of Biomechanics, 2009, doi:10.1016 j.jbiomech.2009.10.046, and Cantounet, Sabine, “Mechanical Behavior of Polymers” Presentation notes from Constitutive Material Modeling Class, Apr. 24-28, 2006.

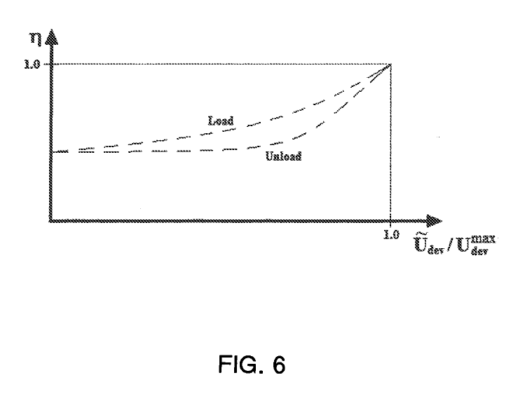

Qi, H. J, and Boyce, M. C., Stress-Strain Behavior of Thermoplastics Polyurethanes. Mechanics of Materials, Vol. 37, 2005, pp. 817-839 experimentally show that the equilibrium (long term) response of thermoplastic polyurethanes differs by a small amount between unloading and reloading in support of the proceeding model. The formulation includes two bounding surfaces η as shown in FIG. 6., with parameters rᵤ^{bound}, mᵤ and βᵤ applied to the unload curve. The loading curve parameters are m₁ and β₁.

$$η = 1 - \frac{1}{{r}_{u}^{bound}} Erf ( \frac{{U}_{dev}^{max} - {\tilde{U}}_{dev}}{{m}_{u} + {β}_{u} {U}_{dev}^{max}} ) ( Unload bounding curve )$$

$$η = 1 - \frac{1}{{r}_{l}^{bound}} Erf ( \frac{{U}_{dev}^{max} - {\tilde{U}}_{dev}}{{m}_{l} + {β}_{l} {U}_{dev}^{max}} ) ( Load bounding Curve )$$

The bounding curves have the same softening parameter, η, when U/Uₘₐₓ=0.0, r₁^{bound} is defined as:

$${r}_{l}^{bound} = {r}_{u}^{bound} \frac{Erf ( \frac{{U}_{dev}^{max}}{{m}_{l} + {β}_{l} {U}_{dev}^{max}} )}{Erf ( \frac{{U}_{dev}^{max}}{{m}_{u} + {β}_{u} {U}_{dev}^{max}} )}$$

### First Unload

During the first unloading (U_{new}<=U_{old}), η is described by the bounding unload curve. The value of r₁ for the loading response is updated at each increment by:

$${r}_{l} = \frac{1}{1 - {η}_{u}} Erf ( \frac{{U}_{dev}^{max} - {\tilde{U}}_{dev}}{{m}_{l} + {β}_{l} {U}_{dev}^{max}} )$$

### Where:

ηᵤ=Current value of η during unload

The updated value of r₁ allows the loading curve to scan along the unload curve in such a way that it crosses the unload curve at the current value of η.

### Reloading

When a reversal occurs, the last value of η is saved as ηᵤᵣ. The strain energy density is saved as Ũ^{ur}_{dev}. Both parameters are used in the scanning unload curve calculation. While the material is being reloaded, the most recent value of r₁ is used to define stress softening. Throughout the secondary and subsequent loadings, scanning unloading curve parameters are determined at each increment. So that the unloading curve does not violate thermodynamic requirements, the scanning curve is required to go through both the current value of η and ηᵤᵣ, as seen below. Requiring the scanning load curve to go through both points necessitates updating two parameters. The choice implemented in the template is to revise the values for the maximum deviatoric strain energy density, U_{dev}′^{max}, and the parameter rᵤ. In this case, it is perfectly acceptable to update the value of maximum deviatoric strain energy density because the value is only in-force while the material is being unloaded. Furthermore, in the limit when the material is reloaded up to and beyond the original maximum deviatoric strain energy density, the updated value would approach and then revert to the original maximum deviatoric strain energy density. The following must be satisfied for the scanning unloading curve to cross the loading curve at the current step and to cross when the reversal occurred:

$${η}_{current} = 1 - \frac{1}{{r}_{u}} Erf ( \frac{{U}_{dev}^{′ max} - {\tilde{U}}_{dev}^{current}}{{m}_{u} + {β}_{u} {U}_{dev}^{′ max}} )$$

In order to ensure the model does not ratchet upwards, which would contradict the behavior prescribed by the bounding unload curve, following relation must also be satisfied:

$${η}_{ur} = 1 - \frac{1}{{r}_{u}} Erf ( \frac{{U}_{dev}^{′ max} - {\tilde{U}}_{dev}^{ur}}{{m}_{u} + {β}_{u} {U}_{dev}^{′ max}} ) = 1 - \frac{1}{{r}_{u}^{bound}} Erf ( \frac{{U}_{dev}^{ max} - {\tilde{U}}_{dev}^{ur}}{{m}_{u} + {β}_{u} {U}_{dev}^{ max}} )$$

which becomes:

$$\frac{1 - {η}_{ur}}{1 - {η}_{current}} Erf ( \frac{{U}_{dev}^{′ max} - {\tilde{U}}_{dev}^{current}}{{m}_{u} + {β}_{u} {U}_{dev}^{′ max}} ) - Erf ( \frac{{U}_{dev}^{′ max} - {\tilde{U}}_{dev}^{ur}}{{m}_{u} + {β}_{u} {U}_{dev}^{′ max}} ) = 0$$

which may be solved numerically for U_{dev}′^{max}. Once this is known, it can be plugged into the previous equation to determine rᵤ.

### Subsequent Unloading

At the point of loads reversal from loading to unloading, U_{dev}′^{max} and rᵤ are held constant so that the stress softening response is given by the equation for η_{current}. If the value of η goes below the bounding curve (when Ũ_{dev}≦Ü^{ur}_{dev}), all the unloading parameters are reset to the unloading bounding curve parameter set and η is recalculated. While all this is occurring, the scanning loading curve is being updated as provided above in the event of any additional load reversals. If at any time Ũ_{dev} becomes equal to the maximum deviatoric strain energy density, all parameters are reset to those that define the bounding curves. An additional modification to the standard Mullins Effect model that is implemented allows the bounding curve variable r to evolve as a function of some deformation metric. This includes letting the variable rᵤ^{bound} vary with the maximum strain energy density reached:

$${r}_{u}^{bound} = \frac{{r}_{u 0}^{bound} + ξ {U}_{dev}^{′ max}}{1 + ξ {U}_{dev}^{′ max}}$$

ζ is a material parameter. This equation represents a decay-type function that enables the softening to increase as the maximum strain energy density increases. Note that if ζ equals zero, then rᵤ^{bound} remains constant.

### Extension of Scanning Mullins Framework

The foundation of the construct is based the concept that the softening history of a material falls between a loading and unloading bounding curve in a self consistent manner (e.g., no discontinuous jumps). The bounding loading and unloading curves are not limited in form to that of Ogden and Roxburgh. Instead, as an example, consider those given by Dorfmann and Ogden as well as Feng and Hallquist:

$$\begin{matrix}η = 1 - \frac{1}{{r}_{u}^{bound}} tanh ( \frac{{U}_{dev}^{max} - {\tilde{U}}_{dev}}{{m}_{u}} ) ( Unload bounding curve ) & ( 1 ) \\ η = 1 - \frac{1}{{r}_{l}^{bound}} tanh ( \frac{{U}_{dev}^{max} - {\tilde{U}}_{dev}}{{m}_{l}} ) ( Load bounding Curve ) & ( 2 )\end{matrix}$$

Again, the parameter r₁^{bound} is defined so that both bounding curves have the same softening parameter, □, when U/Uₘₐₓ=0.0:

$${r}_{l}^{bound} = {r}_{u}^{bound} \frac{tanh ( \frac{{U}_{dev}^{max}}{{m}_{l}} )}{tanh ( \frac{{U}_{dev}^{max}}{{m}_{u}} )} \qquad ( 3 )$$

### First Unload

Following the earlier analysis, during the first unloading (U_{new}<=U_{old}), □ is described by the bounding unload curve. The value of r₁ for the loading response is updated at each increment by:

$${r}_{l} = \frac{1}{1 - {η}_{u}} tanh ( \frac{{U}_{dev}^{max} - {\tilde{U}}_{dev}}{{m}_{l}} ) \qquad ( 4 )$$

### Where:

□ᵤ=Current value of □ during unload

### Reloading

$$\begin{matrix}{η}_{current} = 1 - \frac{1}{{r}_{u}} tanh ( \frac{{U}_{dev}^{′ max} - {\tilde{U}}_{dev}^{current}}{{m}_{u}} ) & ( 5 a ) \\ \begin{matrix}{η}_{ur} = 1 - \frac{1}{{r}_{u}} tanh ( \frac{{U}_{dev}^{′ max} - {\tilde{U}}_{dev}^{ur}}{{m}_{u}} ) \\ = 1 - \frac{1}{{r}_{u}^{bound}} tanh ( \frac{{U}_{dev}^{max} - {\tilde{U}}_{dev}^{ur}}{{m}_{u}} )\end{matrix} & ( 5 b ) \\ \frac{1 - {η}_{ur}}{1 - {η}_{current}} tanh ( \frac{{U}_{dev}^{′ max} - {\tilde{U}}_{dev}^{current}}{{m}_{u}} ) - tanh ( \frac{{U}_{dev}^{′ max} - {\tilde{U}}_{dev}^{ur}}{{m}_{u}} ) = 0 & ( 6 )\end{matrix}$$

Equation (6) can be solved numerically U_{dev}′^{max}. Once this is known, it can be plugged into Equation (5) to determine rᵤ. Subsequent unloadings and reloadings follow the same description as above.

Similar derivations can be done for a wide variety of forms, including but not limited to:

η=a+b log(f(U_{dev}^{max}))(Drozdov) (7a)

η=a+bexp(f(U_{dev}′^{max}))(see Kaliske et al and Drozdov) (7b)

η=a sin h(f(U_{dev}′^{max})) (7c)

Throughout this entire description, the strain energy density function has been used to define the independent variable for the softening response. This does not have to be the case, other scalar values can be substituted for the strain energy density, such as invariants of the deformation tensor, invarients of the stress tensor, etc. or some combination thereof.

In one embodiment, the scanning Mullins calculations may be incorporated as part of the model of an assembled article. The article may comprise a plurality of webs or other materials which each undergo stress cycling both during the manufacturing process associated with the article and the use of the article. Incorporating the scanning Mullins calculations may reduce the compounded errors induced in the output of the model due to the otherwise unaccounted for stress related material softening of each of the individual components of the article through manufacturing and use. In this embodiment, the model may be used to determine the performance of an article using the actual physical properties of the materials incorporated into the article including data necessary to provide the stress-strain relationships of the materials for calculating the scanning Mullins strain related softening associated with either manufacturing the article, using the article or both. Alternatively, the model may be used to determine the physical properties of materials necessary to achieve a desired mechanical performance profile for the article. In this alternative, the performance of the article may be specified and the model may be used to calculate the required stress-strain relationships of the constituent materials. The calculated relationships may then be used to select materials for manufacturing the article, process setting related to manufacturing induces stresses in the materials of the article or both.

As an example, the fit of a diaper or catamenial product during use may be modeled. The model may be structured to optimize the fit of the article according to the forces of interaction between the article and the user. Such forces include the prevention of low force areas or gaps between the product and the body of the user, and the prevention of high forces of interaction between the article and user. Such high forces could lead to pinching or discomfort in the case of the actual article. The model may also calculate the impact stress related softening may have upon the absorbent capacity of the article in use. The model may allow the stress related softening properties of the constituent materials to vary. The output of the model provides the ranges of the stress related physical properties of the materials required to yield an article capable of providing optimal fit during use.

Additional examples include, without being limiting, modeling the performance of polymeric living hinges as a portion of an article or package, or the performance of a handle incorporated into an article or package. As described above, the model may be utilized to determine the performance of a hinge, handle, lid, sidewall, fastening element, or other component element comprised of a selected material having known physical properties and calculated upper and lower bounded scanning Mullins stress related softening performance, or the performance of the particular element may be optimized against a range of possible stress related softening and accompanying physical properties to identify the materials necessary to achieve a desired level of performance in the components and composite article.

Having thus assembled the behaviors, the couplings may be assembled at block 204. In assembling the couplings to be included, reference is again not made to the material to be modeled. Instead, the generalized constitutive model includes a wide range of couplings, one or more of which may be incorporated in a model for a new material. The couplings will be influenced by the behaviors included in the generalized constitutive model. For example, couplings may not be included for behaviors that are not included in the assembly of behaviors. Moreover, here as well, the listing of couplings that might be included is illustrative, and this non-limiting.

The couplings may be expressed in the form of direct or indirect couplings. Where the behaviors are expressed in matrix form, the couplings may be expressed as a coefficient matrix. In fact, to the extent that the behaviors are selected for inclusion or non-inclusion, it may be possible to use a common coefficient matrix for all materials. That is, while the coefficients may remain the same between models, where the behaviors associated with the coefficients are not included, then the coefficients will be not be used. A benefit of such an embodiment is that, to the extent that additional behaviors are included or may be included, the coefficients for the coupling of such behaviors already exist in the matrix.

Having assembled the behaviors at block 202 and the couplings at block 204, the generalized constitutive model that is represented by the behaviors and couplings is stored at block 206 for future use. The storage, as alluded to above, is not limited to any one arrangement of storage devices, whether physical, logical or both. It is possible that the entire model be retained on a single storage device (device 150, for example). Alternatively, separate behaviors or classes of behaviors may be stored separate, as may the couplings.

With the model assembled and stored, the method 200 may continue at block 208. At block 208, the system 100 guides the user through the process of selecting the behaviors and couplings relevant for modeling a particular material. In general terms, system 100 will ask the user for input in regard to the material to be modeled, such as testing data, and the system 100 will provide output that guides the user in selecting the correct behaviors to be included in the model. According to certain embodiments, the system 100 may perform a mathematical analysis of the input before providing the output that guides the user, although according to other embodiments, it may not be necessary for the system 100 to analyze the input any more than determining whether one input or another has been received. Additionally, according to certain embodiments, the system 100 may provide the inputs necessary to model these behaviors in one or more FEA codes based on the input data; according to other embodiments, the system 100 may only provide an indication that one behavior or another should be incorporated into the model.

It will thus be recognized that the process of receiving input and providing output may be achieved according to any of a number of different embodiments. Moreover, the collected knowledge, expertise, or experience reflected in the system 100 that assists the relatively unsophisticated user in assembling a model for a material from the plurality of behaviors and couplings may be expressed in a variety of different fashions in these various embodiments. For example, the knowledge, expertise or experience may be reflected in a series of questions that guide the user, and in particular in the organization, branching, etc. of those questions. Alternatively, the knowledge, expertise, or experience may be reflected in the selection of an analysis of input data that best guides the user in selecting one behavior or another. As a still further alternative, the knowledge expertise or experience may be reflected in the selection of an output of an analysis of input data that provides guidance on the issue of the selection of one behavior or another. For example, when the output is displayed to the user in graphical form, the knowledge, expertise and experience incorporated into the system 100 may be reflected in the selection of certain variables to be plotted, certain scales to be used, certain patterns to be observed, etc.

As but one example of the manner in which knowledge, expertise and experience is incorporated in to the system 100, the input may be requested of the user in a structured form, which form guides the collection of further inputs from the user, and ultimately guides the user to one or more behaviors to be incorporated into a model for a material. According to this example, the system 100 may present to the user a plurality of material or material class options. These options may be presented to the user in the form of an initial question related to the material class, with subsequent follow-up questions that guide the user progressive to a particular material selection. For example, the questions may follow a tree or branching structure, with the class at the trunk and individual materials at the outer branches. As a further example, the classification system could include a branching structure for certain materials, while following another structure for other materials. As a still further alternative, searches of multiple, alternative classification systems may be conducted in parallel.

For example, a branching structure may be developed along the lines of the following non-limiting example for polymeric materials. Polymeric materials may be divided into inorganic and organic polymers. Inorganic polymers may then be separated into natural and synthetic polymers. Further, the natural polymers may be separated into clays and sand, while the synthetic polymers may include fibers and rubbers. Organic polymers may also be separated into natural and synthetic polymers. Natural organic polymers may be separated into polysaccharides, proteins, and natural rubbers. Synthetic organic polymers may be separated into rubbers, plastics, and fibers.

It will be recognized that other polymer characteristics may be used in alternative classification structures. For example, polymers could be separated into thermoset materials and thermoplastic materials. Additionally or alternatively, classes (or subclasses) could be established for amorphous polymers and crystalline polymers. Similarly, the monomer arrangement and characteristics may be used to develop different copolymer classes (alternating copolymers, block copolymers, ionomers etc.).

Another classification structure may be based on the form of the material. For example, the following material forms could be used to classify materials: fibers, bulk, films, fibrous agglomerations, powders/granulars, nonwovens, foams, and composites. Any of these classes may then be further separated or divided. As one example, the composite class may be separated into particulate-filled, fiber-reinforced, bound-agglomeration, and laminate composites.

As still another option, material class (or subclass) options may include cellulosic polymers, olefin polymers, acrylic polymers, aminoplastic polymers (such as melamine), polysaccharide polymers, adhesive polymers, rubber polymers, and polyester polymers. Further, classes could be established for polymeric composites and biomaterials. Each of these classes may include a plurality of subclasses, although certain classes may include no subclasses at all. In the same sense, it is possible to define a class with a single material, although a class may include a plurality of materials.

Cellulosic polymers may be broken into at least two subclasses: fibrous agglomerations and monolithic materials. Fibrous agglomerations may be partially bound (hydrogen bonding or have a binder interspersed in material) or be cohesionless. These materials may be used as, for example, core and storage materials in absorbent articles, such as pads, diapers, etc., and absorbent products, such as towels. Monolithic materials include materials like paper, such as may be used in the cardboard tubes for tampons, for example.

Olefin polymers may be broken into at least the subclasses: fibrous agglomerations, monolithic materials, and foams. Fibrous agglomerations may include nonwoven webs and thick porous materials made from single or bi-component fibers. These materials may be used in absorbent articles, such as pads and diapers, as topsheets and/or secondary topsheets. Monolithic materials include polyethylene and polypropylene webs, which materials may be used packaging materials.

Adhesive polymers may include formulated rubber hotmelt adhesives, ethylene vinyl acetate, polyurethanes, etc. Further, distinctions may be drawn between noncrystalline and crystallizable hotmelt adhesives.

Rubber polymers may include aliphatics, such as ethylene propylene diene (EPDM), as well as urethanes and silicones. Such rubber polymers may include thermoplastic elastomers (TPE), block copolymers based on styrene or other chemistries (such as urethanes) and Kraton block copolymers.

Polyester polymers may include polyethylene terephthalate (PET).

Polymeric composites may include sandwich constructions, as well as composites with filler materials. Sandwich constructions may include a combination of one or more of the above classes (such as from the cellulosic polymers, olefin polymers, and adhesive polymers classes) layered together to form full products or product components. As for composites with fillers, the class may include polymeric matrix composites with fillers, such as CaCO₃, TiO₂, and other such materials as these materials are intended to be a non-limiting set of examples.

Biomaterials include a wide range of materials. The biomaterials may include those external (skin, hair) and internal (fat, muscle, organs, bone) to the human (or animal) body. Biomaterials may also include exudates, such as feces, urine and menstrual fluid. Biomaterials may be polymeric materials, such as polylactic acid (PLA). Furthermore, such biomaterials may be synthetic or from natural sources; examples of the later category include starch and cellulosic materials from trees, corn, etc.

Other materials may also be included. For example, classifications may be established for metals, ceramic, and polymers, with each of these classes broken down in similar fashion to the examples provided above for the polymer class. Also, as was true with polymers, the metals and ceramics classes may be categorized in a number of different manners, and a parallel or series analysis of those various classification systems may be undertaken by the system 100 in selecting the one or more behaviors to be incorporated into the model.

While the embodiments discussed above may involve a sophisticated organization, arrangement, selection, etc. of the questions being asked, which organization, arrangement, selection, etc. then simplifies the analysis of the input and the providing of output to the user, it will be recognized, as stated above, that this is not the only manner in which input may be used by the system 100 to provide an output regarding the behavior or behaviors to be include in a model. According to other embodiments, the system 100 may present the user with a worksheet or template, which worksheet or template is used by the system 100 to request input and display output. According to certain embodiments, the worksheet or template may include embedded equations or other analytical forms that may be used to analyze the input to provide the output displayed to the user.

According to the present disclosure, these worksheets or templates may be presented to the user as a consequence of the user's completion of an earlier set of questions, which questions guide the user to one or a set of worksheets or templates to be used by the user to obtain further guidance. However, the present disclosure equally embraces use of the worksheets or templates by the user without prior identification of any of the worksheets or templates by the system 100 in response, for example, to the user's answers to a preceding set of questions. Thus, the worksheets or templates may be used in combination with the type of classification system described above, or the worksheets and templates may reflect an alternative embodiment to the classification embodiment described above.

Returning then to FIG. 2, the method 200 then proceeds to block 210, wherein the system 100 modifies the model assembled at block 208 according to the test results. While block 210 may be optional according to certain embodiments, it is included in the embodiment illustrated. The modification of the model may be performed automatically. That is, the modification may be performed by an expert system without further input from the user. Alternatively, the system 100 may be programmed to make certain modifications to the model according to the test results, and then output the results of simulations performed using the model to the user. The user may then be prompted to select a model according to the simulation output.

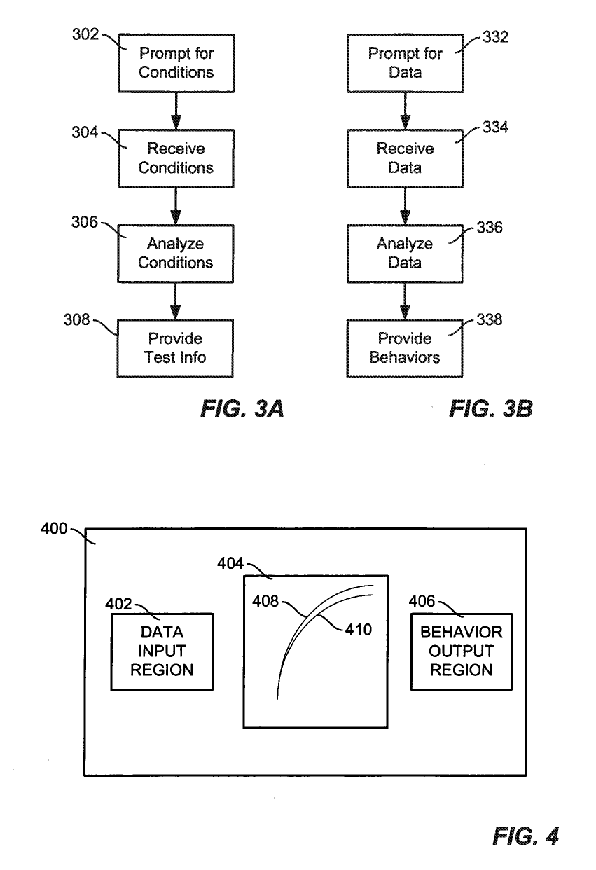

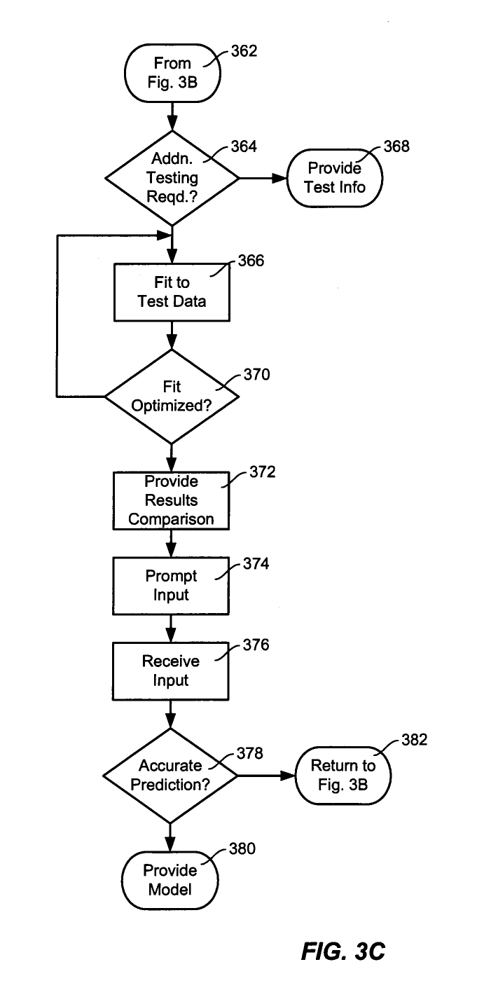

FIGS. 3A-C and 4 collectively illustrate one exemplary embodiment used by the system 100 and user to guide the user in the selection of one or more behaviors to be included in a model for a material, and to then modify the model for use in simulations. In this regard, FIGS. 3A-C may be thought of as an embodiment of carrying out the actions of blocks 208, 210 in FIG. 2, while FIG. 4 illustrates an exemplary image that may be displayed, for example on the display unit 142 of the device 102, in conjunction with the portion of the method illustrated in FIGS. 3B and 3C.

Starting then with FIG. 3A, at block 302, the system 100 may prompt the user for conditions that are important to the material to be modeled so as to provide the user with testing recommendations. For example, the system 100 may prompt the user for loading conditions, boundary conditions, and modes of deformation that are important to the process being modeled. As noted above, the exact nature of the prompts may vary between embodiments, as may the system of organization used relative to the prompts. In response to the prompts at block 302, the system 100 receives information from the user at block 304. In practice, the method may iterate back and forth between blocks 302, 304 until the desired information is collected, or the prompts may be provided at block 302 and the information received at block 304 separately and successively.

The information provided by the user at block 304 is then analyzed by the system 100 at block 306. Depending on, for example, the system 100 may recommend tests conducted under tensile, compressive, or shear loadings. Further, the system 100 may recommend testing conducted under loadings having different directionalities (Machine Direction, Transverse Direction, Out of Plane). The recommendations may be provided to the user in a variety of forms at block 308, and with varying degrees of specificity. According to certain embodiments of the present disclosure, the recommendations may be in the form of a test matrix, specifying for example, the loadings, different levels of strain, number of repetitions, number of material samples, rate conditions, moisture conditions, thermal conditions, etc. According to other embodiments, the recommendations may simply include of the loadings, without specifying the strains levels, numbers of repetitions, moisture and thermal conditions, for example.

Interim to the actions of FIG. 3A and those of FIG. 3B, the user may conduct tests on the material to be modeled. It will be recognized that according to the illustrated embodiment, it is expected that the testing will be performed according to the recommendations provided at block 308 of FIG. 3A. However, the embodiment of the method in FIGS. 3B and 3C is not limited to only such a sequence of events. For example, the user may decide to perform additional testing other than the testing recommended by the system 100 at block 308. For that matter, the user may decide to perform testing other than that recommended by the system 100 at block 308. In fact, the user may plan and perform testing independent of any recommendations that could have been made by the system 100 if the user had elected to consult the system 100 for recommendations. According to such an embodiment, the recommendation section of the method illustrated in FIG. 3A would be considered optional.

Irrespective then of the manner in which the testing occurs, the system 100 may prompt the user for the testing data at block 332 in FIG. 3B. As only one example of how the system 100 may prompt the user, the system 100 may provide a worksheet or template to the user. The worksheet may appear to the user as illustrated in FIG. 4, as designated generally as 400. The worksheet may have a first region 402 for data input, a second region 404 for graphical displays, and a third region 406 for behavior output. The region 404 may already at this point include a graph, pattern or FIG. 408, which graph, pattern or FIG. 408 may be used in subsequent steps of FIG. 3B as explained below.

The method continues to block 334, wherein the user provides and the system 100 receives data. According to the embodiment illustrated in FIG. 4, the region 402 of the display may be designated as the mechanism by which data is received by the system 100, and in particular the worksheet 400. The region 402 may be defined in a variety of manners, and may include a list, array, or matrix format. Data may be entered into the region 402, and thereby received by the system 100 and worksheet 400, via a keyboard 122, for example. However, data may also be imported from other files, which files may be generated by instrumentation during a test, or may be the product of the user's compilation and/or analysis of prior testing. This data may, for example, be cut out of the other files and pasted into the region 402 of the worksheet 400.

The method 300 continues to block 336, wherein the data received by the system 100 at the block 334 is analyzed. As mentioned previously, the analysis may be undertaken via equations or other analytical tools embedded in the worksheet. Alternatively, the worksheet may simply represent a graphical user interface (GUI), which permits the data received from the user by the system 100 to be passed along to other programs, routines, objects, etc. that perform the analysis of the data. The analysis may even be performed on the received data using simplified versions of the behaviors to be incorporated into the model for the material; for example, if the material is to be modeled in three dimensions, the analysis performed during the method 300 may take advantage of a one dimensional model of the same behavior.

Once the analysis of block 336 has been performed, or as the analysis is performed, the method proceeds to block 338, wherein the results of the analysis (e.g., the recommended behaviors) are provided to the user. The results may be provided to the user in a variety of fashions. According to other embodiments, the results may be in the form of a simple yes/no judgment concerning the behavior, for example where a given worksheet is designed to illustrate one behavior (e.g., viscoplasticity, viscoelasticity, etc.). Alternatively, a graphical presentation of the results as may be displayed, as in the region 404 illustrated in FIG. 4. The results of the analysis of the received data may be reflected as a graph, such as a line graph, 410, which is displayed alongside of the graph 408 that reflects, for example, ideal behavior performance. As part of the method, the system 100 may provide an output in the form of constants, etc. used by one or more FEA codes for the behavior or behaviors under consideration. These constants, etc. may be displayed as part of the worksheet 400 in the region 406. As a consequence, the user may be permitted to print the output, which may then be entered into the model for the material to describe the behavior in the relevant code or codes. Alternatively, a “cut and paste” method may be used to import the constants, etc. into the model in the relevant code or codes. It will also be recognized that multiple regions 406 may be provided, each associated with a different FEA code, such that the user may select from among the various output regions for the FEA code that he or she is using.

Having received the recommended behaviors at block 340, the method may proceed to the actions illustrated at FIG. 3C. As illustrated, the actions illustrated in FIG. 3C begin where the method left off in FIG. 3B at block 362. However, the transition need not be instantaneous. For example, it may be that part of the system 100 is programmed to carry out the actions of FIG. 3B, while the actions of FIG. 3C are performed by other parts of the system 100. To access these various parts it may be necessary to switch between different software applications, or even between different hardware or equipment. Thus, according to certain embodiments, the system 100 may prompt the user for information regarding the behaviors selected in FIG. 3B and data from testing previously conducted and may receive this information from the user at block 362.

An analysis may now be performed by the system 100 at block 364 to determine if additional testing is required to proceed with the actions illustrated in FIG. 3C. That is, the method may require specific test data to optimize the model, as discussed below. The test data required to optimize the model may be different in quantity and/or type than the information required to guide selection of the behaviors to be included, as illustrated in FIG. 3B. If the determination is made by the system 100 that no further test data is required, then the method proceeds to block 366. However, if the system 100 determines that further test data is required, then the method proceeds to block 368, at which point the user will be provided with recommendations for testing.

According to certain embodiments of the present disclosure, the determination performed at block 364 may be optional. That is, the system 100 may perform the analysis necessary to make a determination that additional test results should be obtained, but the user may be permitted to override the system recommendation. In those circumstances where the system recommendation regarding test results is overridden, the system 100 may provide a warning that it may not be possible to optimize the model given the test results provided, or that the optimization may only be provided to a certain level. Under such circumstances, if the user is agreeable to proceeding despite the potential for optimization failure or less than complete optimization, the user may be permitted to override the system 100.

If sufficient test data has been provided or if the user has elected to proceed regardless of the sufficiency of the test data, the method proceeds to the block 366. At block 366, the system 100 runs routines to optimize the fit of the model selected in FIG. 3B to the test data received. The optimization routines may be automatically selected by the system 100, or the system may provide the user with a variety of optimization routines from which the user selects the desired routines to be performed. The system 100 may run optimizations according to several different routines to be compared for optimal fit, or may run a single optimization of the model.

At block 370, the determination is made whether the fit or fits of the model are optimized to the test data provided. According to those embodiments of the method wherein the user is permitted to override a system recommendation to perform further testing, the fit may be checked to a certain level of optimization achieved. If the determination is made that the fit is optimized, the method proceeds to block 372. If the determination is made that the fit is not optimized, the method returns to block 366 for further optimization, or optimization according to a different optimization routine. The method may iterate more than once between blocks 366, 370.

As illustrated, blocks 372, 374, 376 follow the optimization of blocks 366, 370. These blocks involve displaying information to the user, soliciting input from the user, receiving the input from the user. That is, at block 372, the results of the optimized model may be shown in comparison to, for example, the actual test results received by the system 100 from the user. The system 100 may then prompt the user for an input at block 374 as to whether the optimized model is accurate, and may receive an input from the user at block 376. This input may then be used at block 378 by the system 100 to determine the accuracy of the model, either independently or in combination with other indicia of accuracy, some of which may be based on automatic analysis of the model by the system 100.

It will be recognized that all or certain of the actions in blocks 372, 374, 376 may be omitted. For example, the system 100 may display the results at block 372, but make the determination at block 380 without soliciting and receiving input from the user at blocks 374, 376. For that matter, the system 100 may proceed directly from block 370 to block 378.

If the system 100, with or without user input, determines at block 378 that the accuracy of the model is acceptable, the method ends with the model being provided to the user at block 380. Alternatively, the system 100 may return the user to FIG. 3B to restart the process of selecting the behaviors based on the test data at block 382. The system 100 may return the user with additional feedback that may provide refinements, or that may suggest the inclusion of different or additional behaviors at block 338.

With the completion of block 210, the method 200 has completed the process of creating a model for the material. This model may now be used in the remaining steps 212, 214, 216. At block 212, one or more simulations are performed using the model created. For example, a simulation may be performed wherein a particular loading pattern is applied to the material irrespective of the geometry of the process. As an alternative, the simulation may be performed wherein the geometry of the process is included. Other factors may also be included in addition to mechanical loading, such as thermal effects. Further, a series of models may be created by repeating the steps 202-210, and the simulations performed at block 212 may be for each of the models under a common loading pattern. As a still further alternative, a series of simulations may be performed using the same model, but with different loadings. At block 214, the output of the simulations is provided to the user, for example by generating video images on the display unit 142.

At block 216, the user makes a determination regarding the material. For example, in the example of a simulation of a single loading, the user may determine whether the material will fail under the loading, and thus be unsuitable for the intended use. Alternatively, in the example of a series of simulations using models for different materials, the user may select one of the materials for use in a product, to provide a vendor with a material specification, for further laboratory testing based on a comparison of the simulation outputs, creation of improved laboratory methods or a Quality Assurance (QA) specification. In regard to the simulation of the single material under various loadings, the user may set a range of suggested tolerances for the a part based on the performance of the material as simulated, or recommend further laboratory testing to corroborated the simulated performance.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of modeling an article comprising a material, the method comprising:
determining the stress-strain properties of the material,
calculating loading and unloading stress-strain relationships for the material,
defining a model of the article including the calculated loading and unloading stress-strain relationship behavior of the material and including a model of the forces selected from the group consisting of: the forces associated with the process of manufacturing the article, the forces associated with using the article, or combinations thereof;
performing simulations using the model for the particular material to define a simulation output;
making a determination regarding the article according to the simulation output.

2. The method according to claim 1, wherein the material comprises a thermoset polymer or a thermoplastic polymer.

3. The method according to claim 1, wherein the material comprises a cellulosic polymer, an olefin polymer, an acrylic polymer, an aminoplastic polymer, an adhesive polymer, a polymeric composite, a polyester polymer, a formulated adhesive or a biomaterial.

4. The method according to claim 1, wherein making the determination comprises selecting a design of the article.

5. The method according to claim 1, wherein making the determination comprises selecting the material for use in a particular product.

6. The method according to claim 1, wherein making the determination comprises selecting a material from a plurality of possible materials for use in a particular product.

7. A system for modeling a material using a generalized constitutive model, the system comprising:
a processor operatively coupled to a memory,
a plurality of behaviors stored in the memory, the plurality of behaviors assembled without reference to a particular material to be modeled, the plurality of behaviors including distinct stress derived loading and unloading behaviors,
a plurality of couplings stored in the memory, each of the plurality of couplings associated with at least one of the behaviors of the plurality of behaviors and defined without reference to a particular material to be modeled;
the processor programmed to select at least one behavior from the plurality of behaviors to define a constitutive model for a particular material; and
the processor being programmed to perform simulations using the constitutive model.

8. The system according to claim 7, wherein the material comprises a thermoset polymer or a thermoplastic polymer.

9. The system according to claim 8, wherein the material comprises a cellulosic polymer, an olefin polymer, an acrylic polymer, an aminoplastic polymer, an adhesive polymer, a polymeric composite a polyester polymer, a formulated adhesive or a biomaterial.

10. The system according to claim 9, wherein the processor provides an output of the simulation to the user.

11. A method for selecting materials comprising a composite article, the method comprising steps of:
defining a model of the article including the stress-related loading and unloading behaviors of at least one of the constituent materials of the article and including a model of the forces selected from the group consisting of: the forces associated with the process of manufacturing the article, the forces associated with using the article, or combinations thereof;
performing simulations of the article using the model and varying the loading and unloading behaviors of at least one constituent material;
selecting constituent materials for manufacturing the article according to the output of the simulations.

12. The system according to claim 11, wherein the plurality of behaviors comprise elastic behaviors, plastic behaviors, rate effect behaviors, damage behaviors, failure behaviors, environmental behaviors, and size effect behaviors.

13. The system according to claim 11, wherein the material comprises a thermoset polymer or a thermoplastic polymer.

14. The system according to claim 11, wherein the material comprises a cellulosic polymer, an olefin polymer, an acrylic polymer, an aminoplastic polymer, an adhesive polymer, a polymeric composite a polyester polymer, a formulated adhesive or a biomaterial.

15. The system according to claim 11, wherein the processor provides an output of the simulation to the user.
